(19) United States
(12) Patent Application Publication
(10) Pub. No.: US 2022/0372890 A1
(43) Pub. Date: Nov. 24, 2022

(54) ACTUATION SYSTEM WITH SPHERICAL PLAIN BEARING

(71) Applicant: Solar Turbines Incorporated, San Diego, CA (US)

(72) Inventors: Sean J. Bentley, National City, CA (US); David Adair, Valley Center, CA (US); David Lau, San Diego, CA (US); Tyler Elsey, San Diego, CA (US); Bill Fahrbach, San Diego, CA (US); Jonathan Leagon, Blacksburg, SC (US)

(73) Assignee: Solar Turbines Incorporated, San Diego, CA (US)

(21) Appl. No.: 17/325,775

(22) Filed: May 20, 2021

(51) Int. Cl. F01D 17/16; F01D 25/16

(52) U.S. Cl. CPC F01D 17/162; F01D 25/16; F05D 2240/12; F05D 2240/50; F05D 2250/241; F05D 2260/31

(57) ABSTRACT

In the compressor of a gas turbine engine, variable guide vanes are adjusted by virtue of connections to an actuation ring that can be rotated within a fixed range of degrees. The connections between the guide vanes and the actuation ring can undergo significant torsional stress. Accordingly, an actuation system is disclosed for reducing the torsional stress experienced by the actuation connections.

### TECHNICAL FIELD

The embodiments described herein are generally directed to an actuation system, and, more particularly, to a system for guide vane actuation in a turbomachine.

### BACKGROUND

The compressor of a gas turbine engine with variable guide vanes generally comprises an actuation ring that is connected by lever arms to outer ends of the variable guide vanes in a stator assembly. The guide vanes are uniformly adjustable within a fixed range of angles by relative rotational movement between the actuation ring and the stator assembly. For example, the actuation ring may be rotated, thereby causing a uniform shift in the ends of the lever arms connected to the actuation ring. This uniform shift in the lever arms causes the guide vanes to uniformly rotate within the stator assembly by virtue of their fixed connections to the opposite ends of the lever arms. During operation, the connections between the actuation ring and guide vanes can undergo significant torsional stress.

U.S. Pat. No. 7,198,461 describes an actuation system with a stator vane that is connected to an adjusting ring by an adjusting lever. A cut-out in one end of the adjusting lever is installed around two stub-like elements on the end of a shank of the stator vane, and affixed to the shank by a fastening screw that is fastened to a threaded shank. The other end of the adjusting lever is fastened to a pin-like element on the adjusting ring by a spherical bearing.

The present disclosure is directed toward overcoming one or more of the problems discovered by the inventor.

### SUMMARY

In an embodiment, an actuation system comprises: at least one guide vane comprising an airfoil and a stem, wherein the stem comprises at least one notch on a radially outward end of the stem; and an actuation connection comprising a lever arm having a first aperture through a first end of the lever arm and a second aperture through a second end of the lever arm, and a spherical plain bearing configured to be mounted inside the first aperture, wherein the second aperture is defined by at least one edge that is configured to engage with the at least one notch in the stem of the at least one guide vane.

In an embodiment, an actuation system comprises, in one or more stages: a stator assembly comprising a plurality of guide vanes extending along radial axes of a longitudinal axis of the actuation system, wherein each of the plurality of guide vanes comprises an airfoil and a stem, and wherein each stem comprises two notches on a radially outward end of the stem; an actuation ring comprising a plurality of mating pins extending along radial axes of the longitudinal axis of the actuation system; and a plurality of actuation connections between a respective one of the plurality of mating pins and the stem of a respective one of the plurality of guide vanes, wherein each of the plurality of actuation connections comprises a lever arm having a first aperture through a first end of the lever arm and a second aperture through a second end of the lever arm, and a spherical plain bearing mounted inside the first aperture and engaged with the respective mating pin, wherein the second aperture is defined by two edges that engage with the two notches in the stem of the respective guide vane.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates a schematic diagram of a gas turbine engine, according to an embodiment;

FIG. 2 illustrates the casing of a compressor, according to an embodiment;

FIG. 3 illustrates a perspective view of an actuation connection, according to an embodiment;

FIG. 4 illustrates a top view of an actuation connection, according to an embodiment;

FIG. 5 illustrates a cut-away perspective view of an actuation connection, according to an embodiment;

FIG. 6 illustrates a cross-sectional side view of an actuation connection, according to an embodiment;

FIG. 7 illustrates a profile of an aperture in a lever arm, according to an embodiment;

and

FIG. 8 illustrates a perspective view of an actuation connection in operation, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

For clarity and ease of explanation, some surfaces and details may be omitted in the present description and figures. In addition, references herein to “upstream” and “downstream” or “forward” and “aft” are relative to the flow direction of the primary gas (e.g., air) used in the combustion process, unless specified otherwise. It should be understood that “upstream,” “forward,” and “leading” refer to a position that is closer to the source of the primary gas or a direction towards the source of the primary gas, and “downstream,” “aft,” and “trailing” refer to a position that is farther from the source of the primary gas or a direction that is away from the source of the primary gas. Thus, a trailing edge or end of a component (e.g., a turbine blade) is downstream from a leading edge or end of the same component. Also, it should be understood that, as used herein, the terms “side,” “top,” “bottom,” “front,” “rear,” “above,” “below,” and the like are used for convenience of understanding to convey the relative positions of various components with respect to each other, and do not imply any specific orientation of those components in absolute terms (e.g., with respect to the external environment or the ground).

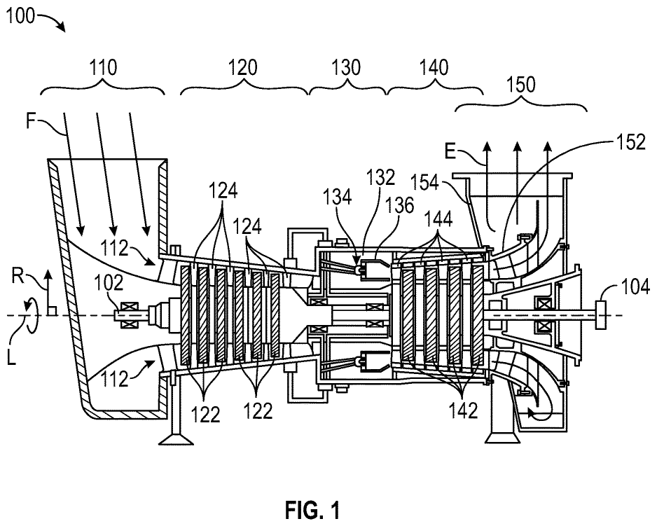

FIG. 1 illustrates a schematic diagram of a gas turbine engine 100, according to an embodiment. Gas turbine engine 100 comprises a shaft 102 with a central longitudinal axis L. A number of other components of gas turbine engine 100 are concentric with longitudinal axis L and may be annular to longitudinal axis L. A radial axis may refer to any axis or direction that radiates outward from longitudinal axis L at a substantially orthogonal angle to longitudinal axis L, such as radial axis R in FIG. 1. Thus, the term “radially outward” should be understood to mean farther from or away from longitudinal axis L, whereas the term “radially inward” should be understood to mean closer or towards longitudinal axis L. As used herein, the term “axial” will refer to any axis or direction that is substantially parallel to longitudinal axis L.

In an embodiment, gas turbine engine 100 comprises, from an upstream end to a downstream end, an inlet 110, a compressor 120, a combustor 130, a turbine 140, and an exhaust outlet 150. In addition, the downstream end of gas turbine engine 100 may comprise a power output coupling 104. One or more, including potentially all, of these components of gas turbine engine 100 may be made from stainless steel and/or durable, high-temperature materials known as “superalloys.” A superalloy is an alloy that exhibits excellent mechanical strength and creep resistance at high temperatures, good surface stability, and corrosion and oxidation resistance. Examples of superalloys include, without limitation, Hastelloy, Inconel, Waspaloy, Rene alloys, Haynes alloys, Incoloy, MP98T, TMS alloys, and CMSX single crystal alloys.

Inlet 110 may funnel a working fluid F (e.g., the primary gas, such as air) into an annular flow path 112 around longitudinal axis L. Working fluid F flows through inlet 110 into compressor 120. While working fluid F is illustrated as flowing into inlet 110 from a particular direction and at an angle that is substantially orthogonal to longitudinal axis L, it should be understood that inlet 110 may be configured to receive working fluid F from any direction and at any angle that is appropriate for the particular application of gas turbine engine 100. While working fluid F will primarily be described herein as air, it should be understood that working fluid F could comprise other fluids, including other gases.

Compressor 120 may comprise a series of compressor rotor assemblies 122 and stator assemblies 124. Each compressor rotor assembly 122 may comprise a rotor disk that is circumferentially populated with a plurality of rotor blades. The rotor blades in a rotor disk are separated, along the axial axis, from the rotor blades in an adjacent disk by a stator assembly 124. Compressor 120 compresses working fluid F through a series of stages corresponding to each compressor rotor assembly 122. The compressed working fluid F then flows from compressor 120 into combustor 130.

Combustor 130 may comprise a combustor case 132 that houses one or more, and generally a plurality of, fuel injectors 134. In an embodiment with a plurality of fuel injectors 134, fuel injectors 134 may be arranged circumferentially around longitudinal axis L within combustor case 132 at equidistant intervals. Combustor case 132 diffuses working fluid F, and fuel injector(s) 134 inject fuel into working fluid F. This injected fuel is ignited to produce a combustion reaction in one or more combustion chambers 136. The combusting fuel-gas mixture drives turbine 140.

Turbine 140 may comprise one or more turbine rotor assemblies 142 and stator assemblies 144 (e.g., nozzles). Each turbine rotor assembly 142 may correspond to one of a plurality or series of stages. Turbine 140 extracts energy from the combusting fuel-gas mixture as it passes through each stage. The energy extracted by turbine 140 may be transferred (e.g., to an external system) via power output coupling 104.

The exhaust E from turbine 140 may flow into exhaust outlet 150. Exhaust outlet 150 may comprise an exhaust diffuser 152, which diffuses exhaust E, and an exhaust collector 154 which collects, redirects, and outputs exhaust E. It should be understood that exhaust E, output by exhaust collector 154, may be further processed, for example, to reduce harmful emissions, recover heat, and/or the like. In addition, while exhaust E is illustrated as flowing out of exhaust outlet 150 in a specific direction and at an angle that is substantially orthogonal to longitudinal axis L, it should be understood that exhaust outlet 150 may be configured to output exhaust E towards any direction and at any angle that is appropriate for the particular application of gas turbine engine 100.

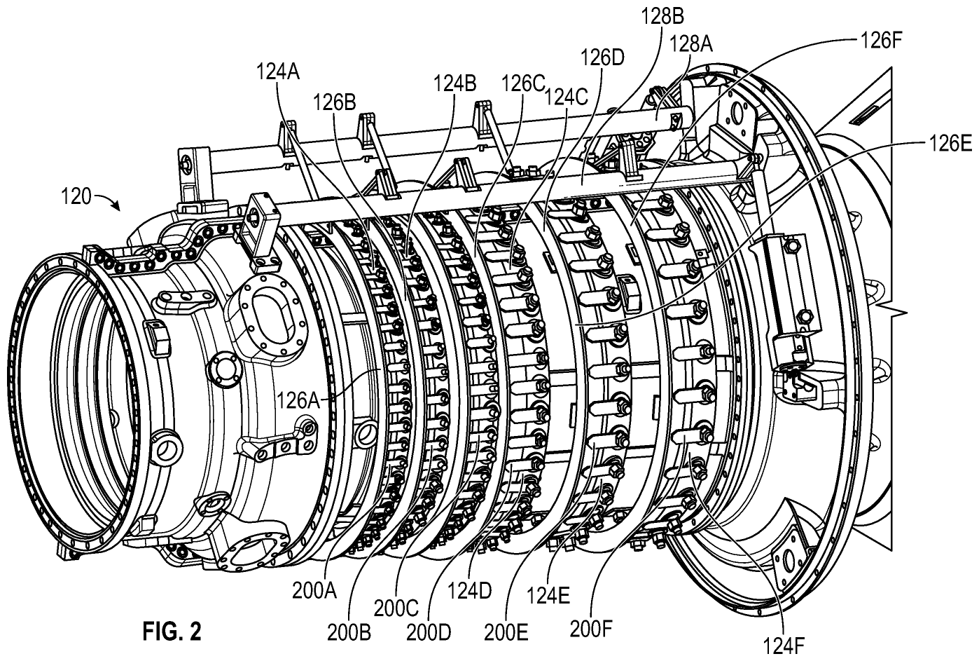

FIG. 2 illustrates the casing of compressor 120, according to an embodiment. One or a plurality of actuation rings 126 encircle the casing of compressor 130. Actuation rings can also commonly be referred to as “adjusting rings,” “synchronization rings,” or “unison rings.” Each actuation ring 126 is connected to the ends of guide vanes in one of stator assemblies 124 by a plurality of actuation connections 200 that are configured to actuate the guide vanes in that stator assembly 124. For example, in the illustrated example, actuation ring 126A is connected to the guide vanes in stator assembly 124A via a plurality of actuation connections 200A, actuation ring 126B is connected to the guide vanes in stator assembly 124B via a plurality of actuation connections 200B, actuation ring 126C is connected to the guide vanes in stator assembly 124C via a plurality of actuation connections 200C, actuation ring 126D is connected to the guide vanes in stator assembly 124D via a plurality of actuation connections 200D, actuation ring 126E is connected to the guide vanes in stator assembly 124E via a plurality of actuation connections 200E, and actuation ring 126F is connected to the guide vanes in stator assembly 124F via a plurality of actuation connections 200F. It should be understood that embodiments may comprise different numbers of actuation rings 126, stator assemblies 124, and/or actuation connections 200 than are illustrated herein.

The particular actuation system that is used is not essential to disclosed embodiments. However, in the illustrated embodiment, each actuation ring 126 may be connected to an actuation assembly 128 that is configured to rotate the actuation ring 126 within a limited range of degrees. For example, a first actuation assembly 128A may be configured to rotate actuation rings 126A, 126C, and 126E, while a second actuation assembly 128B may be configured to rotate actuation rings 126B, 126D, and 126F. The rotation of an actuation ring 126 by an actuation assembly 128 causes the guide vanes within the corresponding stator assembly 124 to uniformly rotate by virtue of the actuation connections 200 between the actuation ring 126 and the stator assembly 124.

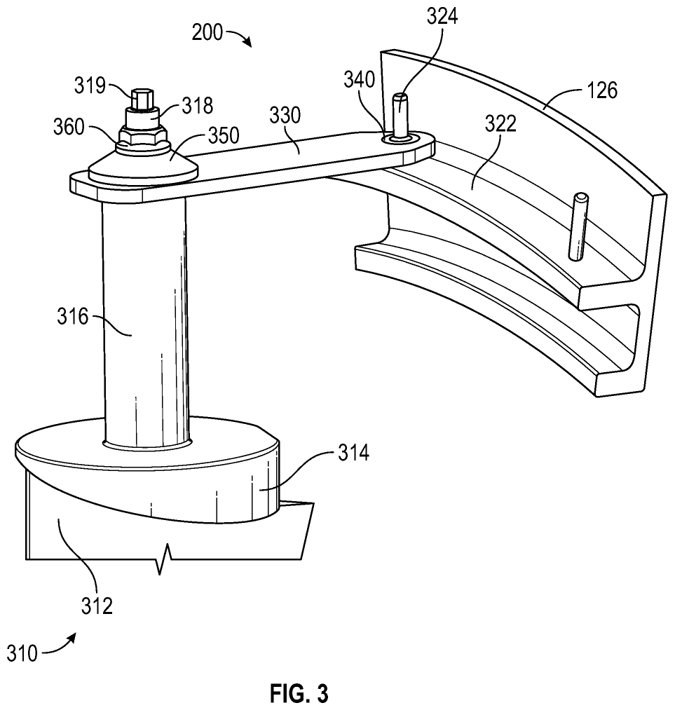

FIG. 3 illustrates a perspective view of actuation connection 200, according to an embodiment. As illustrated, a variable guide vane 310 may comprise an airfoil 312, a platform 314 connected to a radially outward end of airfoil 312, a stem 316 extending radially outward from platform 314, and a shank 318 extending radially outward from the end of stem 316 that is opposite platform 314. As illustrated, the diameter of shank 318 may be less than the diameter of stem 316. The radially outward-most end of shank 318 that is opposite stem 316 may comprise a wrenching flat 319. All of the components of variable guide vane 310, including airfoil 312, platform 314, stem 316, shank 318, and wrenching flat 319 may be made from the same material in a single integrated piece, the same material in different pieces that are joined together by any of various fastening means, or different materials in different pieces that are joined together by any of various fastening means. It should be understood that a plurality of variable guide vanes 310 may be positioned within a stator assembly 124 around longitudinal axis L, with each variable guide vane 310 extending outward along a radial axis from longitudinal axis L and each variable guide vane 310 spaced apart from adjacent variable guide vanes 310 at equidistant intervals.

Actuation ring 126 may comprise a surface 322. A mating pin 324 extends outward, along a radial axis, from surface 322 of actuation ring 126. Mating pin 324 may be fastened to actuation ring 126 through surface 322 via any of various fastening means, such as, by a press fit, mating threads on the outside of mating pin 324 to threads on the inside of an aperture in surface 322, inserting a thread portion of mating pin 324 through surface 322 and mating it to a nut on the other side of surface 322, and/or the like. It should be understood that surface 322 is an annular surface that faces radially outward, and that mating pins 324 may be spaced around the entire circumference of surface 322 at equidistant intervals that correspond to the equidistant intervals between stems 316 of guide vanes 310.

Lever arm 330 comprises two ends along an axial direction. The first end of lever arm 330 may be attached to mating pin 324 via a spherical plain bearing 340 within a first aperture extending radially through the first end. The second end of lever arm 330 may be attached to stem 316 of guide vane 310. In particular, a second aperture extending radially through the second end of lever arm 330 may be positioned around shank 318, such that lever arm 330 rests on the radially outward end of stem 316. A washer 350 may be positioned around shank 318, such that washer 350 rests on lever arm 330 above the second aperture in the second end of lever arm 330. A nut 360 with internal threads may be screwed onto a threaded portion of shank 318, below wrenching flat 319, to clamp washer 350 against lever arm 330. Since guide vane 310 is configured to rotate, wrenching flat 319 can be used to prevent shank 318 from rotating while nut 360 is tightened onto the threaded portion of shank 318.

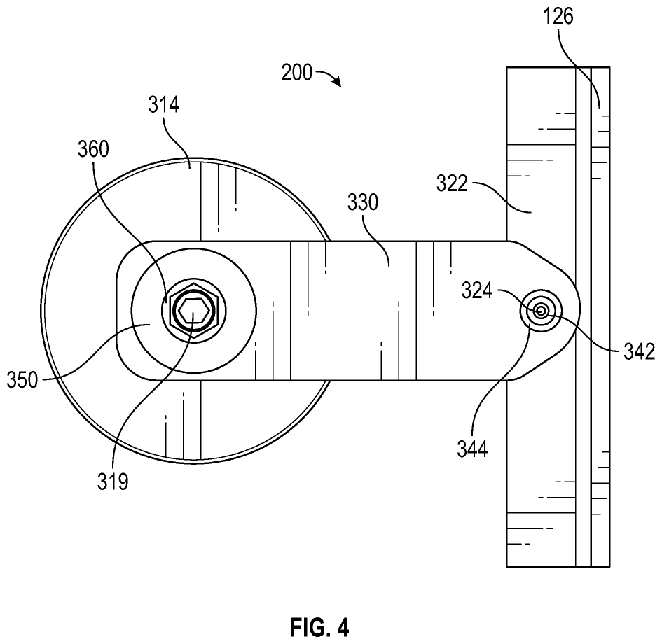

FIG. 4 illustrates a top view of actuation connection 200, according to an embodiment. As illustrated, spherical plain bearing 340 comprises a bearing ball 342 and a bearing race 344. The bearing ball 342 interfaces or engages with mating pin 324 and is encircled by bearing race 344, which interfaces or engages with lever arm 330. Bearing ball 342 may be affixed to mating pin 324 by being slid over mating pin 324 or by any other means, and bearing race 344 may be affixed to lever arm 330 by retaining ring, swaging, or any other means. Bearing ball 342 may move within bearing race 344 to enable relative movement between mating pin 324 and lever arm 330. In an embodiment, spherical plain bearing may be chamfered on one or both exposed ends (e.g., above and/or below lever arm 330).

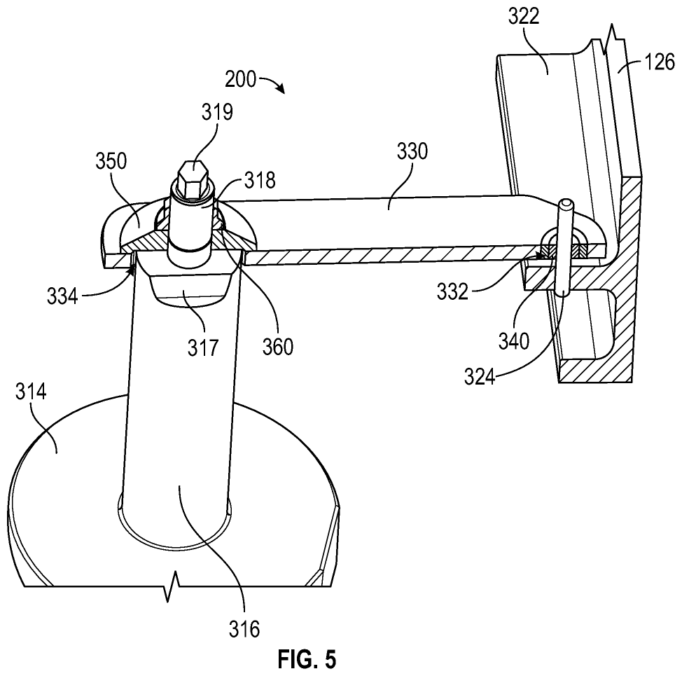

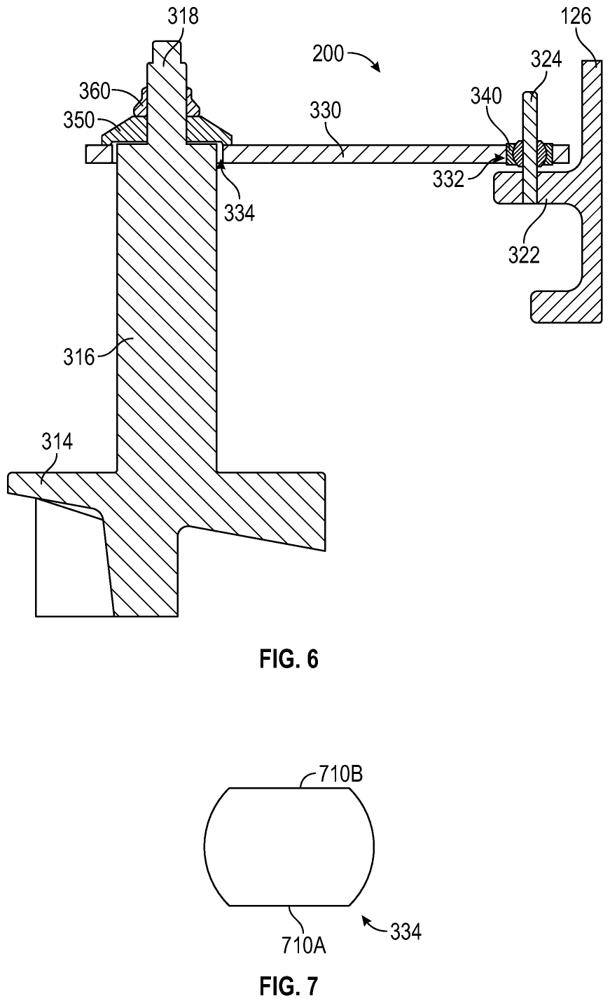

FIG. 5 illustrates a cut-away perspective view of actuation connection 200, and FIG. 6 illustrates a cross-sectional side view of actuation connection 200, according to an embodiment. As illustrated, lever arm 330 comprises a first aperture 332 through a first end, and a second aperture 334 through a second end. Spherical plain bearing 340 is affixed within first aperture 332 and around mating pin 324 to connect lever arm 330 to mating pin 324, while enabling relative movement between lever arm 330 and mating pin 324. For example, swaging may be used to deform bearing race 344 of spherical plain bearing 340 into lever arm 330 around bearing ball 342.

Second aperture 334 is positioned around the radially outward end of stem 316, and is sized and/or shaped to interface with one or more notches 317 in stem 316. In particular, a long edge of second aperture 334 of lever arm 330 interfaces or engages with the laterally facing surface of notch 317 to restrict movement of lever arm 330. As illustrated, the laterally facing surface of notch 317 may comprise an angled or tapered flat. While only one notch 317 is illustrated in FIG. 5, stem 316 may have a single notch 317 or a plurality of notches 317. For example, stem 316 may have a notch 317 that mirrors the illustrated notch 317, but on the opposite side of stem 316 from the illustrated notch 317. In an embodiment, the diameter of second aperture 334, along an axis from the first end to the second end of lever arm 330, is slightly larger than the outer diameter of stem 316 to provide a gap that enables some movement of stem 316 within second aperture 334 (e.g., along the axis from the first end to the second end of lever arm 330). Alternatively, the diameter of second aperture 334 may match the outer diameter of stem 316, so that lever arm 330 forms a tight fit around stem 316, and is unable to move relative to stem 316. The diameter of second aperture 334 and the diameter of stem 316 at notch 317 may be tapered along the radial axis (e.g., greater at a radially inward position than at a radially outward position), so that second aperture 334 of lever arm 330 forms a tapered fit around stem 316 at notch 317.

FIG. 7 illustrates the top-down profile of second aperture 334, according to an embodiment. In the illustrated embodiment, second aperture 334 is not circular. Rather, the profile of second aperture 334 has the shape of a circle or ellipse with two opposing ends cut off along parallel chords. These resulting straight edges 710A and 710B align with notch(es) 317 in stem 316, while the arcs of second aperture 334 align with the circumference of stem 316, but with a slightly greater diameter than stem 316. This prevents lever arm 330 from rotating relative to stem 316. In other words, the rotation of lever arm 330, within the axial plane in which lever arm 330 lies, forces stem 316 to rotate, which in turn rotates airfoil 312 of guide vane 310. Thus, rotation of lever arm 330 forces guide vane 310 to rotate.

### INDUSTRIAL APPLICABILITY

The disclosed embodiments of actuation connection 200 enable actuation of variable guide vanes 310 within a stator assembly 124 in a compressor 120 of a gas turbine engine 100. Specifically, a plurality of actuation connectors 200 connect mating pins 324 on an actuation ring 126 to stems 316 on the outer ends of guide vanes 310 in a stator assembly 124. Rotation of actuation ring 126 causes corresponding rotation in guide vanes 310, so as to control the angle of guide vanes 310 within stator assembly 124. This actuation of guide vanes 310 can be used to control the flow of a working fluid F within compressor 120 of gas turbine engine 100, as that working fluid F flows through stator assembly 124. It should be understood that a plurality of stator assemblies 124 may be paired with corresponding actuation rings 126 to achieve this actuation mechanism for a plurality of stages within compressor 120.

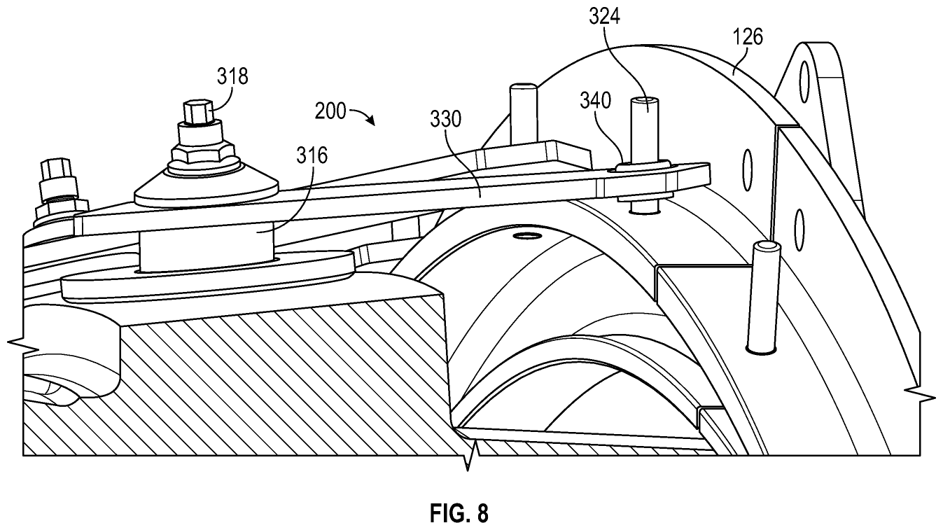

FIG. 8 illustrates a perspective view of lever arm 330 after an example rotation of actuation ring 126, according to an embodiment. Spherical plain bearing 340, which provides the interface or engagement between mating pin 324 and lever arm 330 within first aperture 332, shifts the first end of lever arm 330 as mating pin 324 moves. This movement of the first end of lever arm 330 causes guide vane 310 to rotate by virtue of the engagement between notches 317 and the sides 710 of lever arm 330 defining second aperture 334. Notably, spherical plain bearing 340 enables lever arm 330 to move at a range of angles with respect to mating pin 324. For example, lever arm 330 is capable of rotating outside of the plane that is perpendicular to mating pin 324 and the radial axis. This reduces torsional stress on the various components of actuation connection 200, thereby increasing their durability and the accuracy of the actuation. The disclosed embodiments may also reduce force, which enables utilization of a smaller actuator (e.g., to actuate actuation assemblies 128A and 128B), resulting in less space, heat, weight, and/or energy consumption.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of turbomachine. Hence, although the present embodiments are, for convenience of explanation, depicted and described as being implemented in a gas turbine engine, it will be appreciated that it can be implemented in various other types of turbomachines and machines with variable guide vanes, and in various other systems and environments. For example, while the disclosed embodiments have been primarily described with respect to a stator assembly 124 in a compressor 120, the disclosed embodiments could be equally applied to a stator assembly 144 in a turbine 140. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

1. An actuation system for a turbomachine, the actuation system comprising:
at least one guide vane comprising an airfoil and a stem, wherein the stem comprises
a shank extending radially outward from the stem,
the shank having a wrenching flat at a radially outward end and
at least one notch on a radially outward end of the stem and extending to the shank; and
an actuation connection comprising
a one piece lever arm having a first aperture through a first end of the lever arm and a second aperture through a second end of the lever arm, and
a spherical plain bearing configured to be mounted inside the first aperture,
wherein the second aperture is defined by at least one edge that is configured to engage with the at least one notch in the stem of the at least one guide vane and the diameter of the second aperture at the edge is less than the diameter of the stem radially inward of the notch such that the second aperture cannot pass beyond the notch on the stem.

2. (canceled)

3. The actuation system of claim 1, wherein the shank comprises a threaded portion, wherein the actuation system further comprises a nut, and wherein the nut comprises internal threads that are configured to mate with the threaded portion of the shank.

4. The actuation system of claim 3, further comprising a washer configured to be positioned between the second aperture of the lever arm and the nut, when the internal threads of the nut are mated to the threaded portion of the shank.

5. (canceled)

6. The actuation system of claim 1, wherein the second aperture has a diameter, along an axis between the first end and the second end, that is greater than a diameter of the stem of the at least one guide vane.

7. The actuation system of claim 1, wherein the stem comprises two parallel notches on the radially outward end of the stem.

8. The actuation system of claim 1, further comprising a mating pin, wherein the spherical plain bearing is configured to mate with the mating pin.

9. The actuation system of claim 8, further comprising an actuation ring, wherein the mating pin is affixed to the actuation ring and extends along a radial axis of the actuation ring.

10. The actuation system of claim 9, comprising:
a plurality of the guide vane;
a plurality of the mating pin; and
a plurality of the actuation connection,
wherein a number of the plurality of guide vanes is equal to a number of the plurality of mating pins and a number of the plurality of actuation connections,
wherein the plurality of guide vanes extend along radial axes encircling a longitudinal axis,
wherein the plurality of mating pins are affixed to the actuation ring, along radial axes encircling the longitudinal axis, around a circumference of the actuation ring, and
wherein each of the plurality of actuation connections connects one of the plurality of mating pins to the stem of one of the plurality of guide vanes.

11. A compressor comprising the actuation system of claim 10.

12. The compressor of claim 11, comprising a plurality of the actuation system.

13. A gas turbine engine comprising the compressor of claim 12.

14. An actuation system for a turbomachine, the actuation system comprising, in one or more stages:
a stator assembly comprising a plurality of guide vanes extending along radial axes of a longitudinal axis of the actuation system, wherein each of the plurality of guide vanes comprises an airfoil, a stem and a shank extending radially outward from the stem wherein the shank comprises a wrenching flat at a radially outward end, and wherein each stem comprises two notches on a radially outward end of the stem, each extending to the shank;
an actuation ring comprising a plurality of mating pins extending along radial axes of the longitudinal axis of the actuation system; and
a plurality of actuation connections between a respective one of the plurality of mating pins and the stem of a respective one of the plurality of guide vanes, wherein each of the plurality of actuation connections comprises
a one piece lever arm having a first aperture through a first end of the lever arm and a second aperture through a second end of the lever arm, and
a spherical plain bearing mounted inside the first aperture and engaged with the respective mating pin,
wherein the second aperture is defined by two edges that engage with the two notches in the stem of the respective guide vane and the distance between the two edges is less than the diameter of the stem radially inward of the two notches such that the second aperture cannot pass beyond the notch on the stem.

15. The actuation system of claim 14, wherein each shank comprises a threaded portion, wherein each of the plurality of actuation connections further comprises a nut, and wherein each nut comprises internal threads that mate with the threaded portion of the shank.

16. The actuation system of claim 15, wherein each of the plurality of actuation connections further comprises a washer configured to be positioned between the second aperture of the lever arm and the nut.

17. The actuation system of claim 14, comprising a plurality of stages, wherein each of the plurality of stages comprises the stator assembly, the actuation ring, and the plurality of actuation connections.

18. The actuation system of claim 17, further comprising an actuation assembly configured to rotate the actuation ring in each of the plurality of stages.

19. A compressor comprising the actuation system of claim 18.

20. A gas turbine engine comprising the compressor of claim 19.
